(19) United States
(12) Patent Application Publication
(10) Pub. No.: US 2010/0075867 A1
(43) Pub. Date: Mar. 25, 2010

(54) Rotating Microfluidic Array Chips

(75) Inventors: Paul Chi Hang Li, Coquitlam (CA); Hong Chen, Ningbo (CN)

Correspondence Address: Paul C. H. Li, 945 Madore Avenue, Coquitlam, BC, V3K 3B4, CA

(73) Assignee: Zellchip Technologies Inc., Burnaby (CA)

(21) Appl. No.: 12/561,182

(22) Filed: Sep. 16, 2009

Related U.S. Application Data
(60) Provisional application No. 61/192,615, filed on Sep. 19, 2008.

(51) Int. Cl. C40B 30/06; C40B 40/00

(52) U.S. Cl. 506/10; 506/13

(57) ABSTRACT

A microfluidic chip for carrying out live cell assays and showing observable color change is provided. The microfluidic chip has at least one fluid channel and a plurality of holes punched in a first side of the chip in fluid communication with the at least one fluid channel. Gelled medium containing live cells may be applied to the holes without obstructing the at least one fluid channel. A plain disk is applied to a second side of the chip to seal the fluid channels. Liquid to be distributed to the cells in the holes may be flowed through the at least one fluid channel by spinning the chip. The gelled medium may alternatively contain a reagent to be assayed by producing an observable change upon interaction with a second reagent when the chip is spun.

### RELATED APPLICATIONS

This application claims priority from U.S. Provisional Patent Application No. 61/192,615, filed 19 Sep., 2008

### TECHNICAL FIELD

This invention relates to microfluidic arrays, and in particular to microfluidic arrays suitable for use in conducting assays on live cells and in observing color changes after disk spinning.

### BACKGROUND

There is significant interest in generating cell patterns or arrays for many applications such as drug testing or analysis of cell-cell communications. There are many ways to generate cell arrays. For instance, cytological arrays have been generated by pin spotting.¹ In addition, cell array construction has been accomplished in microfluidic channels, by using patterned protein layers.^{2,3,4,5} Cell arrays can also be constructed by encapsulation in PEG hydrogel.^{6,7,8,9} In both methods of cell array construction, only one sample channel was used. Although the laminar flow has been used to deliver 2 streams of reagents along the same sample channel containing patterned cells,^{10,11} different drug compounds have not been applied to different sample channels intersecting different patterned rows of cells. There remains a need for a method that would allow for parallel drug testing on cell arrays.

The inventors have previously developed a microfluidic microarray (MMA) method to detect multiple DNA samples based on hybridization, as disclosed in PCT Application No. PCT/CA2005/001884 filed 12 Dec. 2005 and published as WO 2006/060922, which is hereby incorporated by reference. The hybridization events occur in the spiral channels that intersect with multiple DNA probe lines. There is a need to extend this multi-sample method to generate radially arranged live cells, to be tested by the spiral flow of reagents. But there is a significant difference between a DNA array and a cell array. For instance, in the previous method, after DNA probe printing, the probe lines were dried so that the spiral channel plate could be readily sealed to the DNA line array. Obviously, this method that requires a drying step will exclude live cell assays, which should be conducted in wet solutions.

In order to satisfy this wet requirement, numerous approaches have been reported. For instance, Chueh et al. adopted to use 2 sets of microchannels, namely the cell channels and sample channels, and employed an optically transparent semiporous polyester membrane to separate them. However, diffusion of reagents from one reagent channel to another occurred along the wet cell channels, leading to contamination of the reagents that interact with each cell in the array.

To resolve the contamination problem, a physical barrier between cell samples must be adopted. Khademhosseini et al. has employed such an approach that involved rows of microwells within the cell channels to retain cells.¹³ Thereafter, the cell channels were sealed with orthogonal reagent channels. However, the regions around the microwells had to be dried to ensure good sealing with the orthogonal reagent channel plate. Nevertheless, the drying step together with the subsequent alignment step is non-trivial.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1. A conceptual drawing of a microfluidic cell array chip. In this embodiment, eight columns (A-H) of holes were punched on five horizontal channels (a-e).

FIG. 2. The rotating microfluidic cell array chip fabricated in polydimethylsiloxane (PDMS): (a) The schematic diagram showing 16 spiral channels fabricated on the chip, with 256 (i.e. 16×16) cell-trapping holes punched on the chip. In the left inset, the holes (dots) and the channels (line) are shown in greater detail. (b) An image of a cell array chip showing the spiral channels and punched holes.

FIG. 3. Optimization of low-melting-point agarose (LMPA) composition. (a) Schematic diagram showing the pre-dyed LMPA formed in the cell-trapping holes. (b) 3% LMPA solutions were added on several holes of the PDMS chip, with inset (i) showing the top view, and inset (ii) showing the mushroom shape of the gelled agarose. (c) Close-up views of the gelled agarose formed at 4 out of 16 holes in two radial rows. (d) The mushroom-like shape of the gelled agarose formed at different compositions.

FIG. 4. (a) Schematic diagram showing LMPA formed as a radial row covering several holes. (b) Front image of the 3% LMPA (pre-stained with blue dye) added along the radial rows of 16 holes. (c) Back image showing no leakage of LMPA into spiral channels. (d) Back image showing leakage of LMPA into 2 spiral channels, resulting in blocking.

FIG. 5. Color change of the trapping agarose by dye solutions delivered by centrifugal flow in spiral channels. (a) (i) 3% LMPA was added in 16 rows of holes on the PDMS chip which was then assembled with a glass disk. (ii) centrifugal flow of color dyed solution through one of the spiral channels showed the blue (i.e. dark) staining. (b) (i) Photograph showing staining by all blue food dye, and (ii) photograph showing staining by alternate red and blue food dye. (c) Closeup of a row of the cell trapping agarose stained by alternate dye solutions. The insets show the staining of the “mushroom stem”, which was previously gelled in the holes. (d) (i) Schematic illustration showing staining by all blue food dye (from FIG. 5(b)(i))—open circles represent blue spots visible where holes filled with agarose have been stained by blue food dye, as represented by open circles. (ii) Schematic illustration showing staining by alternative red and blue food dye (from FIG. 5(b)(ii))—open circles represent blue spots visible where holes filled with agarose have been stained by blue food dye, while filled circles represent red spots visible where holes filled with agarose have been stained by red food dye.

FIG. 6. Images of HL-60 cells in the cell trapping agarose. (a) Cells stained by fluorescein diacetate (FDA) (i) at 10× magnification, with the dashed circle showing the location of the hole, and (ii) at 20× magnification. (b) Cells stained by trypan blue (i) at 10× magnification, and (ii) at 20× magnification. (c) Survival ratio of cells after being trapped inside agarose.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The inventors have resolved the need to conduct live cell array assays using wet liquids by putting forward two technical solutions. First, the cells may be applied to a chip 20 in holes 28 punched as radial lines, which prevents diffusion of reagents between the holes 28 and avoids the need for an alignment step between the chip 20 and a plain disk 40. Second, viable cells may be embedded in suitable cell trapping medium, for example low melting point agarose (LMPA), which maintains cell viability. Cell media may be mixed with the cell trapping medium to provide nutrients to further increase cell viability. For example, RPMI media may be used for HL-60 cells, or αMEM may be used for leukemia cells. In this way, different reagents can be delivered via fluid channels 22, which may be, for example, radial channels or spiral channels, or straight channels, intersecting with the radial rows of cells 36 embedded in the lines of cell trapping reservoirs 28 punched on the same channel plate 20.

The chip 20 may be made of a polymeric material, for example polydimethylsiloxane (PDMS), polymethylmethacrylate (PMMA), or polycarbonate (PC). Examples using both the colored dyed solution and fluorescent vital stain have been performed by the inventors, as discussed in detail below.

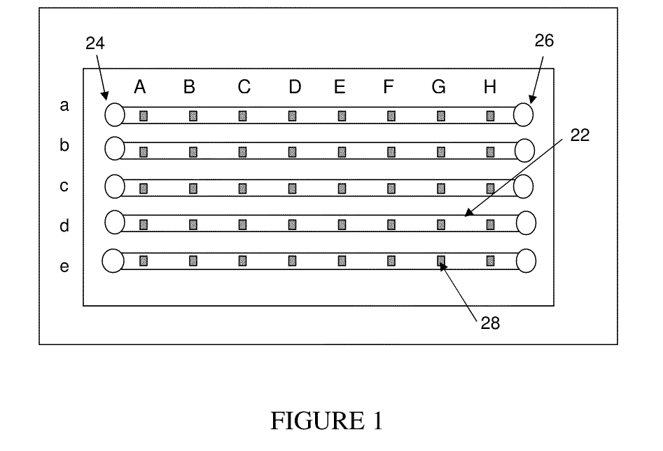

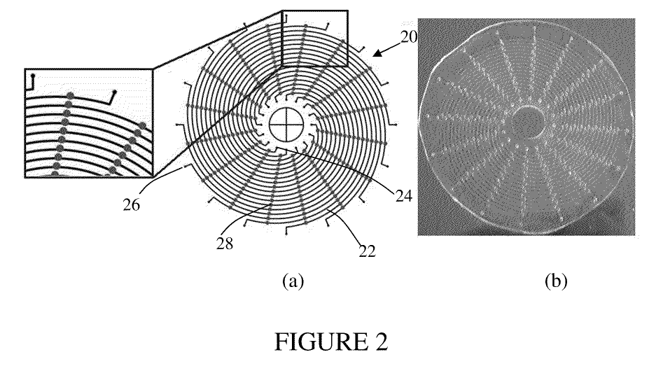

In one embodiment, the chip 20 may include spiral fluid channels 22. Other patterns of fluid channels 22, such as straight lines, circular arcs, or zigzag lines covering only a portion of the chip 20, may also be used. As shown in FIG. 1, in some embodiments, the chip 20 may include horizontal channels 22 with holes 28 punched therein. FIG. 1 illustrates how the holes 28 may be punched in the fluid channels 22. Where the chip 20 includes spiral fluid channels 22, the holes 28 may be punched in radial rows, each one of the holes 28 being in fluid communication with one of the spiral fluid channels 22. Exemplary radial rows of the holes 28 are shown in the embodiment of the chip 20 illustrated and pictured in FIG. 2. In some embodiments, the chip 20 may have 16 spiral channels 22, and 16 radial rows of cells 36. Each one of the 16 spiral channels 22 intersects one hole 28 in each of the 16 radial rows 36. Thus, there may be a total of 256 holes 28 in the chip 20. The spiral channels 22 may have inlet reservoirs 24 and outlet reservoirs 26 punched at suitable locations, to facilitate the application of liquid to the chip 20.

To apply cells to the chip 20, the cells may be incorporated into a suitable cell trapping medium capable of forming a suitably rigid gel to prevent the medium applied to the holes 28 from entering the fluid channels 22 and thereby obstructing them. However, the gel should not be so rigid as to damage the cells contained therein. The medium may then be applied to the holes 28, either singly, or in radial rows 36. The medium may then be permitted to gel, and a plain disk 40 sealed over the fluid channels 22 to seal the fluid channels. Alternatively, the plain disk 40 may be pre-sealed to the chip 20 before the cell-medium solution is applied to the holes 28. The plain disk 40 may, for example, be pre-sealed to the chip 20 to provide sealed fluid channels before the chip 20 is provided to a user to conduct assays using the chip 20. Fluid containing reagents to be delivered to the cells in the holes 28 may then be applied to the inlet reservoirs 24, and the chip 20 spun at a suitable speed to distribute the fluid to the holes 28 containing the gelled medium.

This method may be used to monitor the interaction not only between drugs or other molecules and cells, but also to monitor interaction between two different proteins, or between two different chemicals, etc. The interaction of two reagents such as molecules, cells, nucleic acids, proteins, chemicals, and/or drugs may produce an observable change, such as a change in colour, fluorescence, gas formation, precipitation, and the like. A chip 20 may be used to assay such observable changes by applying a trapping medium (such as, for example, low melting point agarose, photopolymerizable hydrogel made from polyethylene glycol, or thermoreversible gel made from Pluronic) optionally including a first reagent to the holes 28 on the chip 20, applying the plain disk 40 to seal the fluid channels 22 (or alternatively using a pre-sealed chip 20 wherein the fluid channels 22 have already been sealed by the application of the plain disk 40 prior to application of the trapping medium), permitting the trapping medium to gel in the holes 28 without entering the fluid channels 22, then placing a liquid, optionally containing a second reagent, in the inlet reservoir 24. The chip 20 may be spun to distribute the liquid through the fluid channels 22, and the observable change may be monitored after the chip 20 has been spun or rotated.

### EXAMPLES

### Materials and Methods

### 1.1 Materials

Low Melting Point Agarose (LMPA) was purchased from Invitrogen (Burlington, ON). Sodium dodecyl sulphate (SDS), fluorescein diacetate (FDA) and poly-L-Iysine were purchased from Sigma-Aldrich (Oakville, ON). Circular glass disks (1 mm thick, 4″ dia. with a center hole of 0.59″ in diameter) were obtained from Precision Glass & Optics (Santa Ana, Calif. USA). Photoresist SU-8 and its developer were purchased from MicroChem Corporation (Newton, Mass. USA). Sylgard® 184 silicone elastomer base and its curing agent were obtained from Dow Corning Corporation (Midland, Mich. USA).

### 1.2 Procedures

### 1.2.1 Fabrication of PDMS Channel Chips

The chips 20 were prepared according to the procedure described previously.¹⁴ Briefly, the photomask with microchannel pattern was printed on a transparency film. An SU-8 molding master having 25 μm-high positive relief structures was fabricated. PDMS prepolymer was cast against the molding master to yield the polymeric channel plate. As shown in FIG. 1, the illustrated PDMS chip 20 has 16 spiral channels 22. In the examples, each spiral channel is 1 mm wide, spaced 2 mm apart, and is 25 μm deep. At the starting and ending points of each spiral channel, 2 mm diameter holes were punched to serve as the solution inlet and outlet reservoirs 24, 26.

On each spiral channel 22, 16 cell trapping holes 28 (2 mm in diameter) were punched (see FIG. 2(a) inset). These holes 28 were constructed along 16 imaginary radial single rows of 16 holes each, or radial double rows of 8 holes each, thus resulting in a total of 256 holes 28, as shown in FIG. 2(b). This chip 20 including both the cell trapping holes 28 and spiral channels 22 was to be sealed against a plain circular disk 40.

### 1.2.2 Formation of Cell Trapping Agarose

Low melting point agarose (LMPA, 1-4%), which was prepared in PBS, was heated in boiling water bath for 5 min. The melted agarose was put in a 37° C. water bath until use. The LMPA solution, after mixing with a blue dye, was introduced to the cell trapping reservoirs 28 on the chip 20 (i.e. the 16 reservoirs 28 along each radial row as shown in FIG. 2(b)). The solution was introduced into the holes 28 either individually, or as a continual radial stripe. The agarose composition was optimized to be 3% so that it would flow into the reservoirs 28 and gel, but would not flow into the spiral channels 22. After 1 min of agarose gelling, the chip 20 was sealed with a plain glass disk 40, enclosing the spiral channels 22.

### 1.2.3 Centrifugal Flow of Reagents

To introduce solution into the spiral channels 22, the solutions were placed at the inlet reservoirs 24. Then the chip 20 was put on a rotating platform, and was spun at 1000 rpm. The liquid flow inside the channels 22 was examined by stroboscope light.

### 1.2.4 Cell Viability Assay

HL-60 cells were sub-cultured every 3 days using RPMI medium at 5% CO₂ and 37° C. The cells were washed with PBS for 3 times and re-suspended in fresh cell media before experiment. Low melting point agarose (LMPA, 3%), which was prepared in PBS, was heated in a boiling water bath for 5 min. The melted agarose was put in a 37° C. water bath until use. The cells were mixed with LMPA at a final cell density of 5×10⁵/ml. Then the cell mixture was introduced to the cell trapping reservoirs on the PDMS chip. After 1 min, the chip 20 was sealed with a glass disk 40. Thereafter, reagents (e.g. FDA or trypan blue) were added to the inlet reservoirs 24 for centrifugal liquid delivery by spinning the glass disk at 1000 rpm. The optical imaging, fluorescent or bright-field, was achieved using an inverted microscope (Nikon™ TE300).

### Results and Discussion

### 2.1 Example 1

### The Cell Trapping Agarose

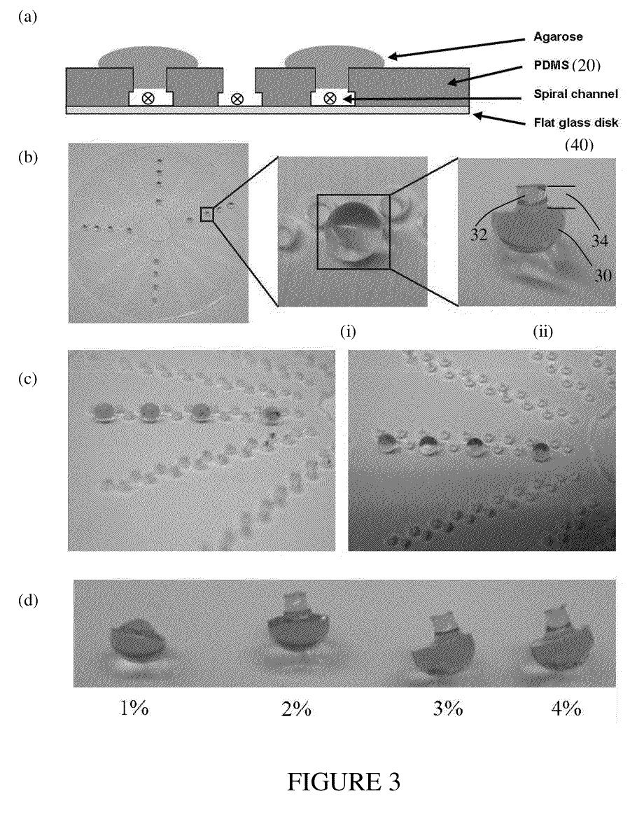

The LMPA solution was put into the holes 28 that were punched through the chip 20 (see the schematic diagram in FIG. 3(a)). The warm agarose solution was applied into individual holes, shown as discrete droplets in FIG. 3(b). After gelling, LMPA would take the form of the cell trapping hole 28, thus giving rise to a mushroom-like shape with a head 30 and a stem 32, see FIG. 3(b) insets. FIG. 3(c) shows that only 4 out of the 16 cell trapping holes are filled with the blue agarose, and the droplets are greater than the diameter of the hole, resulting in a mushroom shape. More preferably, the LPMA can be added in a smaller amount so that the 16 holes can be filled with agarose without overlapping one another.

Preferably, the agarose solution should flow into the cell trapping holes 28, but should not get into, and hence block, the spiral channels 22. So, several concentrations of LMPA (from 1% to 4%) were tested. The 1% LMPA ran into the spiral channel 22 because the solution was not viscous enough. Moreover, this solution was too soft to maintain the mushroom shape after gelling (see FIG. 3(d)). On the other hand, 2% and 3% LMPA did not leak into the spiral channels, and they were mechanically strong enough to maintain a good mushroom shape (see FIG. 3(d)). Finally, since the 4% LMPA was too rigid after gelling, and this would damage the entrapped cells or slow down the diffusion of reagents delivered in a subsequent step, the 3% LMPA was selected for use in subsequent experiments.

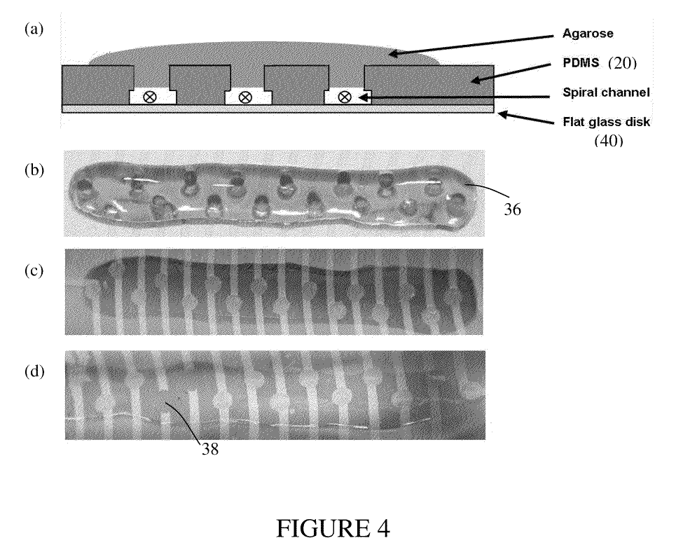

For the 3% LMPA, the length 34 of the mushroom stem 32 was measured to be less than the 2-mm thickness of the chip 20 (or the 2-mm depth of the cell trapping hole 28). Accordingly, there was enough space between the mushroom stem 32 and the 25 μm deep spiral channel 22 for the staining solution to pass. In addition, FIG. 4(a)-4(d) shows a schematic diagram of the 3% LMPA being added as a radial row 36, covering several cell trapping holes. FIG. 4(b) depicts an image of the blue-dyed LMPA stripe as viewed from the top of the chip 20; whereas FIG. 4(c) shows the image as viewed from the bottom. In this image, the holes 28 looked bright and the shade of its color was the same as that of the channels, suggesting that no LMPA leaked into the channels 22 and the channels 22 were not blocked. FIG. 4(d) depicts the situation in which blockage has occurred in two spiral channels 30, showing that the hole 28 has the same shade of color as the agarose gel.

### 2.2 Example 2

### The Centrifugal Flow in Spiral Channels

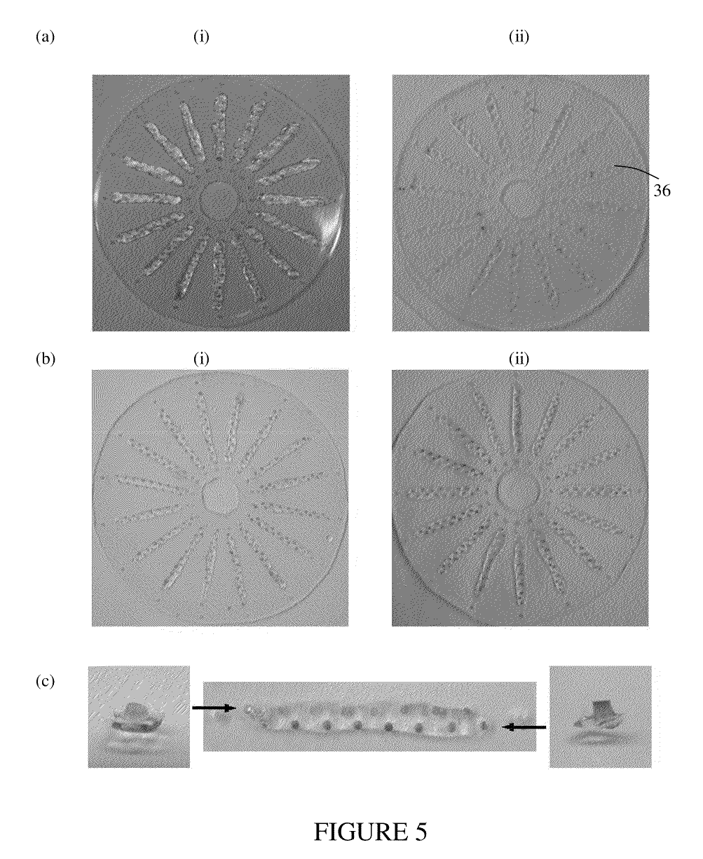

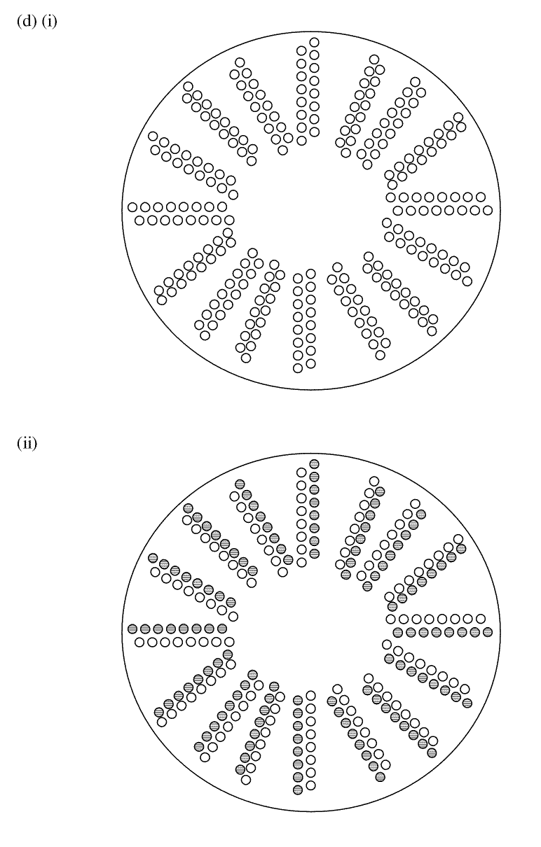

In this example, the inventors tested the staining of just the LMPA (i.e. the cell trapping medium) by the reagent delivered using centrifugal pumping via the spiral channels. As shown in FIG. 5(a)(i), 16 radial rows of LMPA 36 were applied on the cell array chip 20 at the location of the cell trapping holes 28 after chip 20 was rotated or spun. A blue dyed solution was delivered via one spiral channel 22 to show immediate staining of the agarose. This is seen as a discontinuous blue (i.e. dark) anti-clockwise spiral track in FIG. 5(a)(ii), spiraling out from the centre to the perimeter of the cell array chip 20. When the dyed solution flowed past each of the cell trapping holes 28, the solution was accumulated inside the hole 28, and reached the bottom of the agarose to stain it.

Subsequently, the food dyes were applied into all of the 16 spiral channels 22. FIG. 5(b)(i) shows the result of all of the 256 holes being stained in blue, as shown schematically in FIG. 5(d)(i). Thereafter, two food dyes (blue and red) were used to stain alternate spiral channels 22. FIG. 5(b)(ii) showed the chip 20 after the delivery process was completed, and it was observed that the agarose inside the holes 28 has been stained in blue and red colors alternately (as shown schematically in FIG. 5(d)(ii)). Such color changes illustrate the end result after disk spinning, and such a method could be applied to use as a one-time rotation indicator.

FIG. 5(c) is an enlarged region showing one radial row of agarose that has been stained alternately in red and blue. The lighter coloured dots on the top row are areas where the agarose inside the holes 28 has been stained blue, while the darker coloured dots on the bottom are areas where the agarose inside the holes 28 has been stained red. In accordance with the method described, all of the holes 28 could potentially be stained in 16 different colors. After the mushroom-like LMPA was pulled out and cut, it was confirmed that only the bottom of the mushroom stem 32, but not the mushroom head 30, was stained by the food dye. This is different from the previous results in FIG. 3(a)-(d), which was obtained with the LPMA premixed with blue dyes. Since the distance between the holes 28 was 5 mm (from center to center), they were far enough to avoid cross contamination from diffusion of reagents over adjacent holes, as evidenced by the clear regions among individual red or blue dots. Even better, if the agarose were added individually into each cell trapping hole 28, contamination would not be able to occur.

The colour change observed in the trapping hole 28 can only occur after chip 20 is spun or rotated. In other words, the colour change is the result of the occurrence of chip rotation.

### 2.3 Example 3

### Cell Viability Assay

In order to embed live cells in this example, the inventors used low melting point agarose (LMPA). This material has been widely used in single-cell electrophoresis or comet assay, and the cells remained viable at the gelling temperature of agarose at 37° C.¹⁵ Alternatively, for certain cell types, photopolymerizable hydrogel made from polyethylene glycol (PEG), or thermoreversible gel made from Pluronic may be used in place of LMPA. Hydrogel made from PEG has been widely used for many cell types, such as fibroblast^{6,9} (rat skeletal myoblast, HEK 293 and Caco-2 cells),⁷ (NIH-3T3, AML12 and mES cells),⁸ and (hepatocyte and macrophage).⁹ Hydrogel made from Pluronic F127 (FI27) was used to encapsulate human liver carcinoma¹⁶ cells (HepG2) HMEC-1 (endothelial) and L6 (muscle) cell lines. However, PEG hydrogel has not been used with HL-60 cells, and it was found that this material is not compatible with HL-60 cells.

The chip 20 was then employed for cell viability test using trypan blue and fluorescein diacetate (FDA). FDA is a vital stain used to distinguish live cells from dead ones because only live cells contain the enzymes to hydrolyze FDA to produce fluorescein. But trypan blue only stains cells with compromised cell membranes but not live cells. Hence, FDA and trypan blue were chosen to test live and dead cells, respectively on the chip.

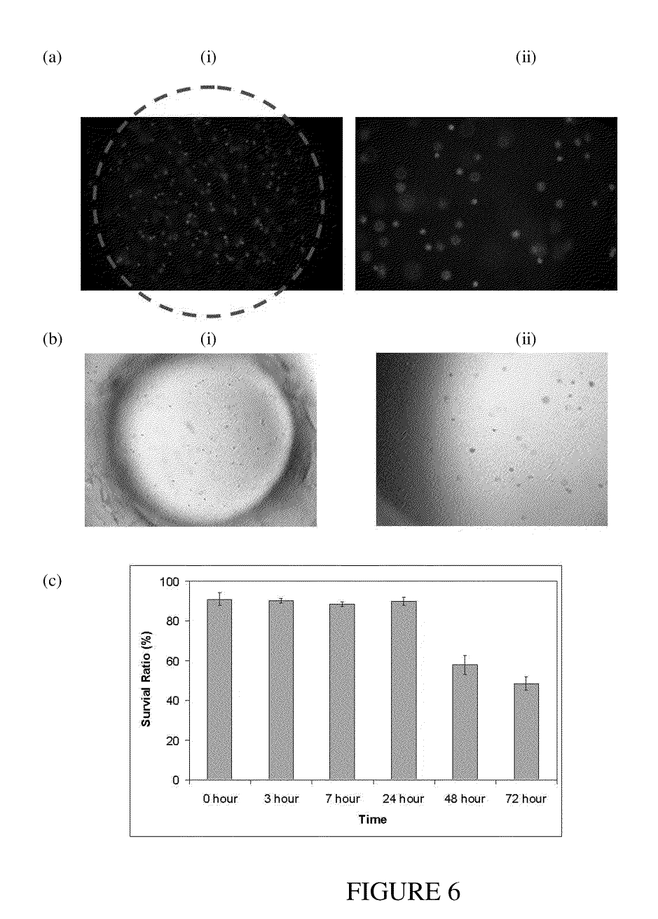

After the HL-60 cells were mixed with the warm LMPA solution (i.e. the cell trapping medium), they were introduced to the cell trapping holes. After the gelling process was completed on the chip, the FDA solution (10 μM) was flowed though the channels. FIG. 6(a)(i) shows the fluorescent image (10× magnification) obtained at the cell trapping hole. It is observed that almost all of the cells are fluorescent (the dotted circle indicates the outline of cell trapping reservoir). A magnified fluorescent image (20×) of the live cells is shown in FIG. 6(a)(ii). Since the cells were at different levels in the agarose, some cells appeared to be out of focus.

To test dead cells, HL-60 cells were preheated to 90° C. in the LMPA solution. FIG. 6(b)(i) show the 10× bright-field images of the dead cells inside the hole before treatment by trypan blue. In FIG. 6(b)(ii), the cells have been treated by trypan blue, showing all the cells were stained in blue.

The number of dead cells as stained by trypan blue was also used to determine the survival ratio of cells trapped in the agarose for different durations. As shown in FIG. 6(c), the survival ratio was high, suggesting the cell remained alive up to 24 h, which is probably due to the presence of sufficient cell media inside the agarose. But when the trapping time was more than one day, the cell media was consumed, and so many cells began to die and the survival ratio dropped greatly.

The above examples demonstrate the usefulness of the cell array chip for use in a cell viability assay. The design offers flexibility in cell array lines generation, multi-cell multi-reagent capability, and simultaneous centrifugal liquid delivery to multiple cells. These aspects have been demonstrated on a 16-channel microfluidic chip, but could likewise be used in microfluidic chips having differing numbers of channels or different configurations. The method may also be used in a non-biological context to reveal an observable change obtainable at the trapping holes only upon disk rotation, which observable change may be due to the interaction of two reagents when the chip is spun.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### REFERENCES

1. J. Korbelik, M. Cardeno, J. P. Matisic, A. C. Carraro, C. MacAulay Cellular Oncol. 2007, 29, 435-442.
2. S. N. Bhatia, U. J. Balis, M. L. Yarmush and M. Toner, Biotechnol. Prog., 1998, 14, 378-387.
3. Khademhosseini, A., Suh, K. Y., Jon, S., Eng, G., Yeh, J., Chen, G.-J., Langer, R., Anal. Chem. 2004, 7, 3675-3681.
4. Mrksich, M., Chen, C. S., Xia, Y., Dike, L. E., Ingber, D. E., Whitesides, G. M., Proc. Natl. Acad. Sci. USA 1996, 93(20), 10775-10778.
5. Tokano, H., Sui, J., Mazzanti, M. L., Doyle, R. T., Haydon, P. G. Porter, M. D., Anal. Chem. 2002, 74, 4640-4646.
6. D. R. Albrecht, V. L. Tsang, R. L. Sah and S. N. Bhatia, Lab Chip, 2005, 5, 111-118.
7. T Peterbauer, J Heitz, M Olbrichb and S Hering, Lab Chip, 2006, 6, 857-863.
8. G T Franzesi, B Ni, Y Ling, and A Khademhosseini, J. Am. Chem. Soc. 2006, 128, 15064-15065.
9. Koh, W. G.; Itle, L. J.; Pishko, M. V. Anal. Chem. 2003, 75, 5783-5789.

10. Kaji, H., Nishizawa, M., Matsue, T., Lab Chip 2003, 3, 208-211.
11. Takayama, S., Ostuni, E., LeDuc, P., Naruse, K., Ingber, D. E., Whitesides, G. M. Nature 2001, 411, 1016.
12. B Chueh, D Huh, C R Kystsos, T Houssin, N Futai, S Takayama, Anal. Chem. 2007, 79, 3504-3508.
13. A Khademhosseini, J Yeh, G Eng, J Karp, H Kaji, J Borenstein, 0 C. Farokhad and R Langer, Lab Chip, 2005, 5, 1380-1386.
14. Lin Wang, Paul C. H. Li, Hua-Zhong Yu, Ash M. Parameswaran, Anal. Chim. Acta, 2008, 610, 97-104.
15. Paul C. H. Li, Elena Lam, Wynand P. Roos, Margaret Z. Zdzienicka, Bernd Kaina, Thomas Effert, Cancer Research, 2008, 68, 4347-4351.
16. S. F. Khattak, S. R. Bhatia, S. C. Roberts, Tissue Engineering 2005, 11(5-6), 974-983.

What is claimed is:

1. A micro fluidic chip having:
at least one fluid channel; and
a plurality of holes punched in a first side of the chip in fluid communication with one of the at least one fluid channels.

2. A microfluidic chip according to claim 1 further comprising a plain disk in sealing engagement with a second side of the microfluidic chip.

3. A microfluidic chip according to claim 1 wherein the fluid channel is a spiral channel.

4. A microfluidic chip according to claim 1 wherein the at least one fluid channel further comprises an inlet reservoir and an outlet reservoir.

5. A microfluidic chip according to claim 1 further comprising gelled medium applied to at least one of the holes.

6. A microfluidic chip according to claim 5 wherein the gelled medium is applied to the holes arranged in radial rows.

7. A microfluidic chip according to claim 5 wherein the diameter of the fluid channel is sufficiently narrow to prevent the gelled medium from entering the fluid channel.

8. A microfluidic chip according to claim 5 wherein the diameter of the fluid channel is sufficiently narrow to prevent the gelled medium from obstructing the fluid channel.

9. A microfluidic chip according to claim 5 further comprising living cells within the gelled medium.

10. A microfluidic chip according to claim 5 wherein the gelled medium is low melting point agarose.

11. A method of assaying live cells on a chip, the method comprising:
applying the cells suspended in medium to holes formed on a first side of the chip, the holes being in fluid communication with sealed fluid channels formed on a second side of the chip;
permitting the medium to gel in the holes without entering the fluid channels;
placing a liquid to be applied to the cells in an inlet reservoir of the fluid channels; and
spinning the chip to distribute the liquid through the fluid channels.

12. A method according to claim 11 wherein a user applies a plain disk to seal the fluid channels on the second side of the chip.

13. A method of assaying observable changes on a chip, the method comprising the steps of:
applying a medium optionally containing a first reagent to holes formed on a first side of the chip, the holes being in fluid communication with sealed fluid channels formed on a second side of the chip;
permitting the medium to gel in the holes without entering the fluid channels;
placing a liquid to be applied to the cells in an inlet reservoir of the fluid channels, the liquid optionally containing a second reagent; and
spinning the chip to distribute the liquid through the fluid channels.

14. A method according to claim 13 wherein a user applies a plain disk to seal the fluid channels on the second side of the chip.

15. A method according to claim 13 wherein the observable change is selected from the group consisting of visible color formation, fluorescence, turbidity, opaque substance formation.

16. A method of assaying observable changes according to claim 13, wherein the observable change is produced only after the chip has been spun.
